(19) United States
(12) Patent Application Publication
(10) Pub. No.: US 2017/0344075 A1
(43) Pub. Date: Nov. 30, 2017

(54) ELECTRONIC DEVICE DOCK WITH AUTOMATED CONNECTIONS

(71) Applicant: Jason Kuznicki, Stow, OH (US)

(72) Inventor: Jason Kuznicki, Stow, OH (US)

(21) Appl. No.: 15/606,715

(22) Filed: May 26, 2017

Related U.S. Application Data
(60) Provisional application No. 62/342,400, filed on May 27, 2016.

(51) Int. Cl. G06F 1/16; G06F 1/26; G06F 13/38

(52) U.S. Cl. CPC G06F 1/1684; G06F 1/1632; G06F 13/38; G06F 1/26; G06F 13/385; G06F 1/266

(57) ABSTRACT

An automated dock for electronic devices may be adapted to position a mobile device and establish any number of connections automatically. Connection quality may be detected and indicated to a user with colored LED lights. Logic circuitry may include iterative processes for establishing a connection with an electronic device including repositioning the device and/or repositioning components of an embodiment.

### I. BACKGROUND OF THE INVENTION

### A. Field Of Invention

The present invention relates to a mechanical and electronic device dock with improvements in making automated connections to handheld electronics such as cell phones and tablets.

### B. Description Of The Related Art

Charging stations for mobile electronic devices are commonly available; however, all existing charging stations have certain limitations. More specifically, a persistent problem with charging stations is that person is required to coordinate forming an electrical connection between their device and the charging station. This is particularly problematic in use cases like automobiles where it is important for the driver to devote attention to driving rather than ancillary tasks like plugging in devices. Elderly and disabled persons may also experience difficulty in using presently available charging stations. What remains missing in the art is a charging station that can align itself with the power ports of various devices of differing sizes and form an electrical connection for recharging the mobile device.

Some embodiments of the present invention may provide one or more benefits or advantages over the prior art.

### II. SUMMARY OF THE INVENTION

Some embodiments may relate to an automated docking device, comprising: a cradle adapted to receive a mobile electronic device. The cradle may have a bottom support wall and an adjacent back support wall that cooperate to receive the mobile electronic device, and a pair of opposing lateral walls adjacent to the bottom support wall and back support wall. Embodiments may also include a pair of opposing automated positioning modules extendable by one or more microprocessor-controlled motors from the opposing lateral walls toward a center of the cradle. The pair of opposing automated positioning modules may be adapted to laterally position the mobile electronic device between the pair of opposing lateral walls. A device sensor may be included and may be adapted to detect the presence of the mobile electronic device in the cradle according to a state change of the device sensor, wherein the device sensor is further adapted to communicate its state to the microprocessor. Embodiments may also include an electrical connector adapted to engage the mobile device in electronic communication when the mobile electronic device is properly positioned.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1 is a perspective view showing one version of the present invention;

FIG. 2 is an exploded view showing the key components of the invention;

FIG. 3 is a perspective view showing the alternate detachable solar charging accessory;

FIG. 4 is a perspective rear view showing the rear attachment for optional automotive mounting;

FIG. 5 is a perspective detail view of the positioning module for one embodiment;

FIG. 6 is a perspective internal detail view of the adjusting module for one embodiment;

FIG. 7 illustrates an embodiment having spring-loaded connection to avoid potentially damaging force due to misalignment;

FIG. 8 shows two options for detection of a successful connection;

FIG. 9 is a side view of a typical wired connector plug for an electronic device, and some options for modifications to improve automatic connection and disconnection;

FIG. 10 is an isometric view of examples of the various sizes that embodiments may take on; and

FIG. 11 is a partially exploded detailed drawing of an embodiment.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Embodiments may comprise a docking station for electronic mobile devices such as, without limitation, mobile phones and/or tablet computers. A docking station may include a pair of opposing motorized positioning modules. The positioning modules may be adapted to engage devices having various thicknesses, sizes, and/or shapes and move the mobile device so as to position it over a motorized or stationary electrical connection. The electrical connection may be adapted to automatically engage a properly positioned mobile device, and may make iterative attempts to engage it based on a positioning algorithm and feedback from components indicating success or failure to connect. Accordingly, embodiments enable a user to charge and/or dock a mobile device without requiring close attention or coordination thus leaving the user free to focus on other tasks such as driving.

Some embodiments may include components and logic for calibrating the embodiment to connect with a particular device, e.g. an iPhone or a Galaxy smartphone. Notwithstanding calibration, it may be advantageous to include adaptations enabling embodiments to iteratively attempt connection, detect success or failure, and readjust the mobile device's position as necessary in response to detection of success or failure.

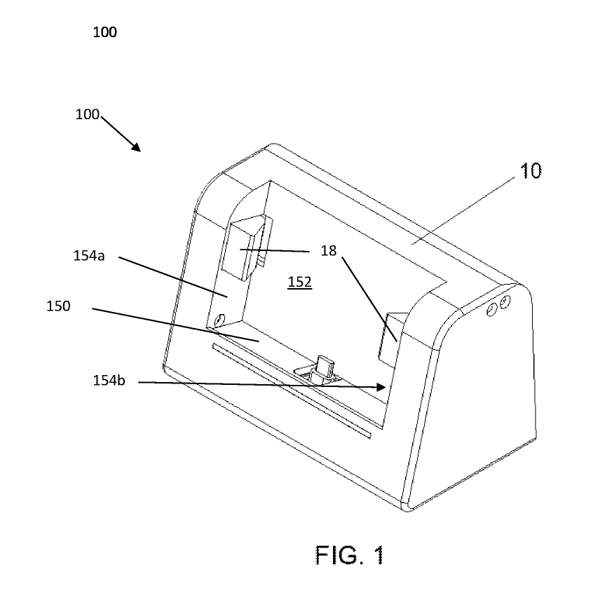

Referring now to the drawings wherein the showings are for purposes of illustrating embodiments of the invention only and not for purposes of limiting the same, FIG. 1 is a perspective view of one embodiment of the present invention in an assembled state showing a mobile device cradle 100 having a housing 10. The housing includes a bottom support wall 150 and back support wall 152 against which a mobile device may rest when inserted into the cradle 10. The housing also includes a pair of opposing lateral walls 154a and 154b from which a pair of opposing automated positioning modules 18 may extend. The positioning modules 18 may be driven by one or more electric motors under microprocessor control.

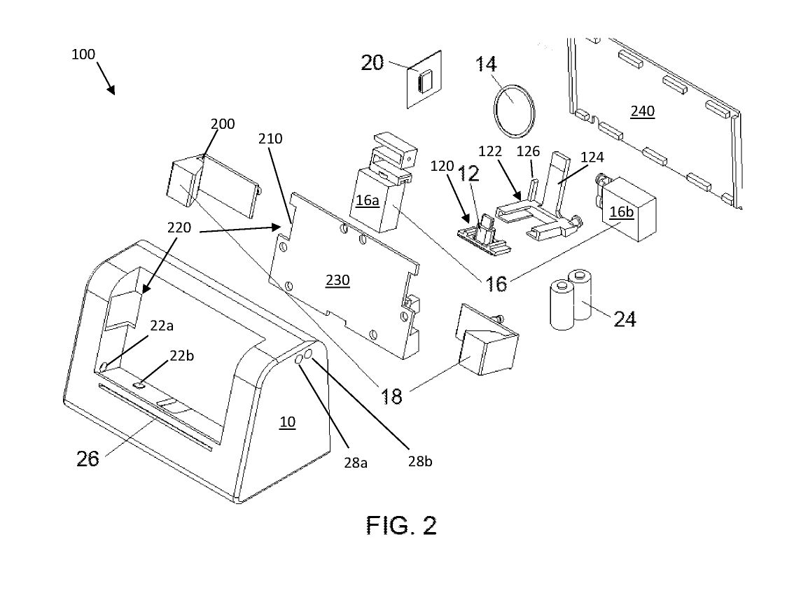

FIG. 2 shows the cradle 100 for electronic mobile devices with automated connections in an exploded view which includes several components that position an electrical connector such as wired plug connector 12 and/or wireless connection module 14. The housing 10 includes a rear closure 240 adapted to enclose the internal components of the embodiment.

In FIG. 2, electromechanical components 16a and 16b are collectively referred to by reference numeral 16 and may comprise one or more microprocessor controlled motors. More particularly, a mobile positioning module drive 16a drives the location of the mobile device positioning modules 18. The means of mechanical communication between the drive 16a and the positioning modules 18 will be shown in more detail in subsequent figures. The positioning modules are responsible for repositioning a mobile device to align it with the plug 12 and/or wireless module 14. Similarly, a plug and/or wireless positioning module drive 16b drives the location of the plug 12 and/or wireless connection module 14. The plug 12 is shown in FIG. 2 mounted in a carriage 120 adapted to slide into a shoe 122. Collectively, the carriage 120 and shoe 122 structures cooperate with the electromechanically component 16b to support and position the plug 12 and/or wireless connection module 14.

Although the embodiment shown in FIG. 2 shows the positioning modules 18 being extendable only a short distance before a post structure 200 of the positioning module 18 contacts a mechanical stop 210, it is contemplated to have larger slots 220 in the back of the housing 10 and chassis 230 to allow for additional travel distance. Such a modification would enable an embodiment to accommodate mobile devices having a wider variety of dimensions.

With continuing regard for FIG. 2, when a mobile device is placed in the cradle 100, embodiments are adapted to sense the location of the mobile device relative to the plug 12 and/or wireless connector 14. Thus, an embodiment may determine whether the mobile device is suitably positioned to effect electronic communication with the plug 12 and/or wireless connector 14. If misalignment is detected then the embodiment may actuate the positioning modules 18 to properly align the mobile device. Alternatively, embodiments may make no measurement of the position of a mobile device relative to the connectors and instead rely on mechanical structure of the positioning modules 18, chassis 230, and/or housing 10 to properly align the unit. The skilled artisan will appreciate that embodiments may include logic circuits 20 such as, but without limitation, integrated circuits and/or microprocessors to automate control of the various sensors, motors, and/or moving parts involved in positioning a mobile device.

Embodiments may include a device sensor such as an optical sensor 22a and/or a mechanical button 22b to detect the presence of a mobile device in the cradle 100. Embodiments may also include a battery 24 to power the various components of the embodiment, and may even provide charging power to a connected electronic device. An indicator 26 light(s) may be included to alert the user to the connection state of a mobile device, such as indicating a successful or unsuccessful mechanical connection attempt, and/or indicating whether full electronic communication has been established.

Also shown in FIG. 2, is structure adapted to initiate a disconnection process and/or related firmware routine. Particularly, structures 28a and 28b illustrate cooperative infrared emitter 28a and detector 28b components. The skilled artisan will appreciate that such components are common and widely available, and that they typically operate by emitting near infrared light (i.e. NIR or near IR), such as from an infrared LED, and sensing infrared reflections from an IR-reflective body a short distance away, e.g. a user's hand for instance. By way of a non-limiting example, an embodiment may monitor the sensor 28b for electrical signals that would indicate a reflection. Such a signal may then be used by the logic circuit 20 to trigger a routine adapted to retract the positioning modules 18 and/or plug 12.

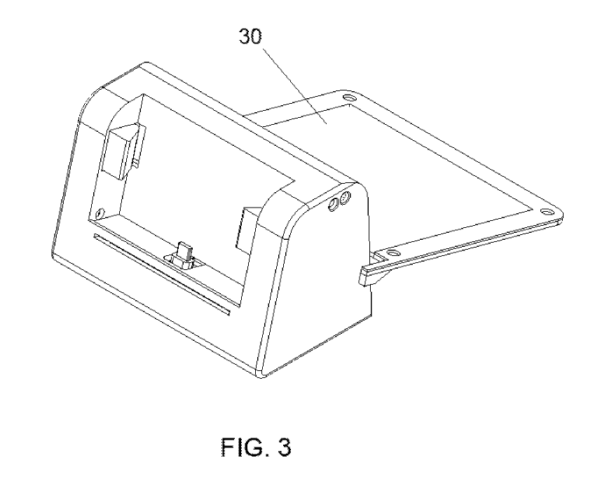

FIG. 3 shows a perspective view of an embodiment with an optional solar charging attachment 30. The solar charging attachment 30 may be manually positionable to direct it toward the sun or other light source. Alternatively, embodiments may include well known automated means for tracking the position of a light source that include electric motors adapted to reposition in response to changes in power output from the solar cells. Power generated by the charging attachment 30 may be stored in batter 24.

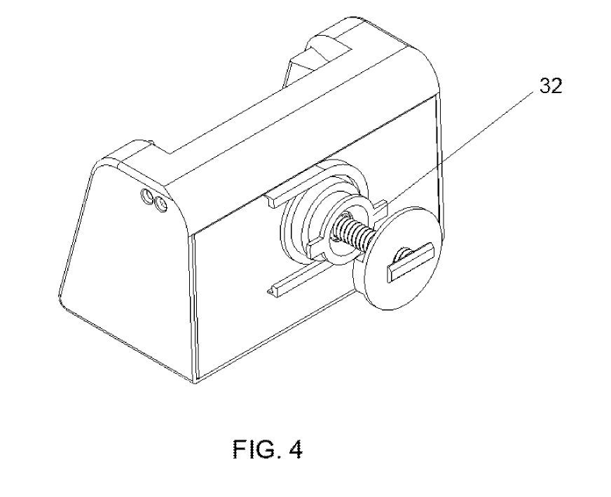

FIG. 4 is a side elevation view of an embodiment showing an optional attachment clip 32 that may be suitable for an automotive setting. The illustrated clip 32 is adapted to engage an automotive console. However, other adaptations for mounting to a vehicle are also contemplated such as, and without limitation, a suction cup co-operable with a windshield or dashboard, and adaptations for engaging a console cup holder.

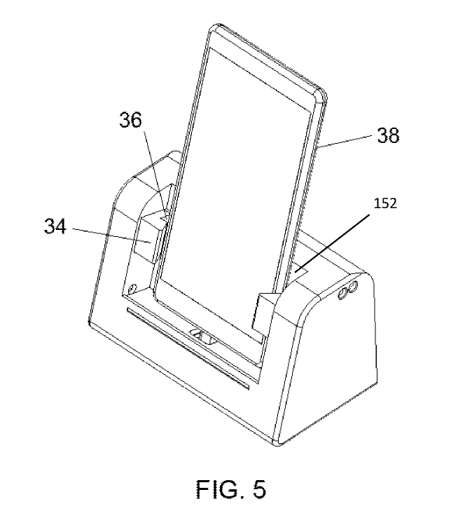

FIG. 5 illustrates how a mobile electronic device 38 seats in an embodiment. A chamfered or wedge-shaped non-gripping positioning head 34 and recessed gripping pad 36 are shown engaging a front edge of the mobile device 38. The electronic device 38 may be placed in the cradle thereby actuating a device sensor 22a and/or 22b. A state change of the device sensor is communicated to a central microprocessor, e.g. logic circuit 20, which activates the positioning head 34 to move toward the center of the embodiment. The non-gripping wedge-shaped positioning head 34 contacts the mobile device 38 first allowing the device 38 to slide into position. The gripping pad 36 comes into contact with the device 38 when the device 38 is wedged securely against a back support wall 152, thus securing the mobile device 38 after the mobile device 38 has slid into a suitable position. In embodiments where two or more positioning heads 34 are used their movement is coordinated to ensure the device 38 is properly centered. For instance, and without limitation, the positioning heads 34 may be driven by the same electromechanical actuator component, e.g. 16a.

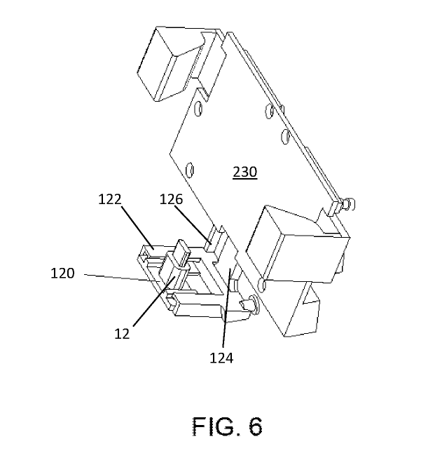

FIG. 6 shows one option for the adjustment of a wired plug module 12 that uses a carriage 120 and shoe 122. The plug module 12 may be rigidly mounted to the carriage 120, which is slideable within the shoe 122 in a fore and aft direction relative to the embodiment. The shoe 122 may be in turn rigidly connected to a lift 124 adapted to raise and lower the shoe 122 relative to the embodiment. The lift 124 includes indicator post 126 that trips a switch (not shown) indicating the end of the lift's 124 range of motion. The indicator post 126 also sets a minimum distance between the shoe 122 and chassis 230. Thus, the plug 12 is positionable about two axes. Adjustability of the wired connection module 12 allows embodiments to adapt to various thicknesses of the electronic devices that will be connected. Adjustability also allows use even if the device to be connected is in a protective case. Adjustment may be manual or automatically controlled and applied to wired or wireless connection modules.

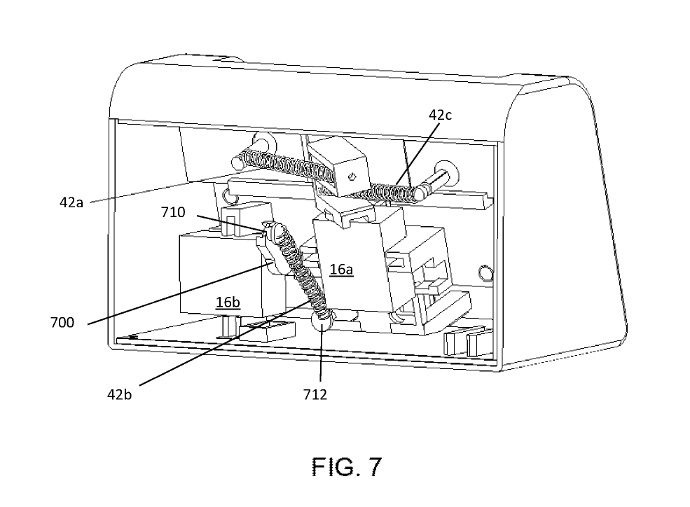

FIG. 7 shows structure to limit the force applied by the electromechanical components 16a and/or 16b. More specifically, coil springs 42a, 42b, and 42c provide a protective effect preventing damage to mobile devices placed in the embodiment or even to the embodiment itself. Spring 42b is mounted to cam 700 through an anchor 710 that is free to rotate relative to the cam 700. The anchor 710 is seated in a semicircular opening at one end of the cam 700. The cam 700 is rigidly mounted at its other end to a shaft (not shown) of the electromechanical component 16b. Accordingly, the cam 700 converts the rotational motion of the shaft into translational motion adapted to stretch the spring 72b. Springs 42a and 42c are similarly linked to a cam 701 and the positioning modules 18.

Once the mobile device 38 is positioned and electronic communication is established, the plug module 12 and the positioning modules 18 can be locked mechanically by means well known in the art such as, and without limitation, a locking cam system or through magnetic braking of the electric motors 16. For instance, locking structures may be advantageous to prevent the springs from reversing the motor and/or reducing the plug force after de-energizing the motors.

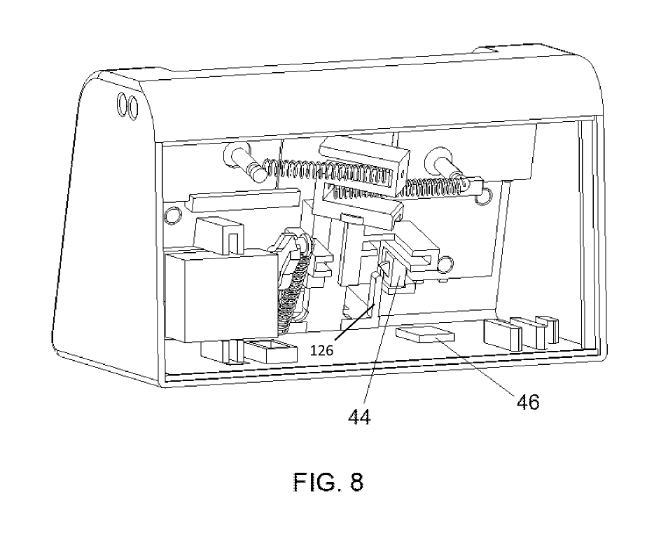

FIG. 8 shows a switch 44 that engages when a set relative movement of the indicator post 126 is achieved and is not hindered by an obstruction. This is one of several methods contemplated for the detection of a successful wired connection. For instance, in one embodiment an unhindered plug will travel a predetermined distance and contact a switch which indicates that the plug has connected. A current detection module 46, may also be used to detect either a successful wired or wireless connection. In the either case, the current detection module 46 may be iteratively measured and a signal fed back to the microprocessor to adjust the positioning module(s) 34 in order to maximize the current flow and optimize the connection.

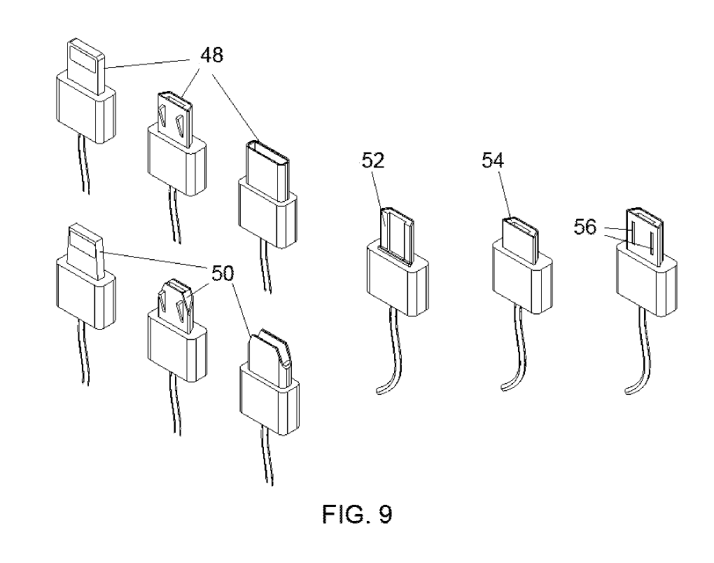

According to some embodiments, the force for holding a plug in an electronic device may be maintained by an interference fit of the plug 12 and carriage 120, by force from internal or external retaining clips, or by magnetic force. However, embodiments may automatically provide the initial plugging force and the holding force, thus the need for an interference fit, retaining clip, or magnetic retainer may be obviated and may accordingly be omitted without departing from the scope of the invention. Furthermore, the plug geometry may be altered to improve the effectiveness of making automated connections by decreasing the precision necessary in positioning mobile device. More specifically, FIG. 9 shows a typical wired connection plug 48 for an electronic device. In contrast, embodiments may include any number of modifications to a plug end geometry such as tapering 50, narrowing 52 or shortening 54. The geometry and force of any retaining clips 56 may also be modified or omitted.

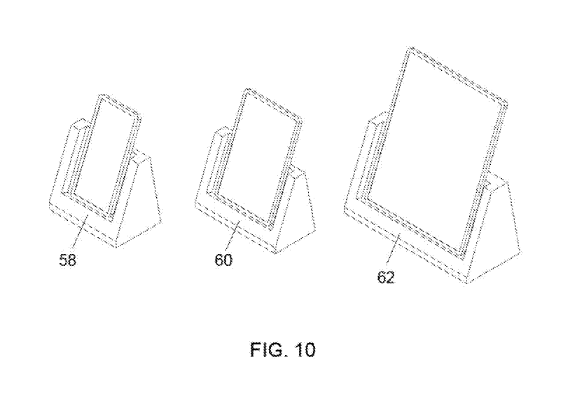

Embodiments may be scalable to hold and connect any size of electronic device and FIG. 10 shows some possible sizes and illustrates that embodiments are not limited to a particular size. This includes a small size 58 for a four or five inch smartphone or media player, a larger size 60 for six or seven inch smartphone or tablet, and an even larger size 62 that may be compatible with computing devices such as ten inch tablets or laptop computers.

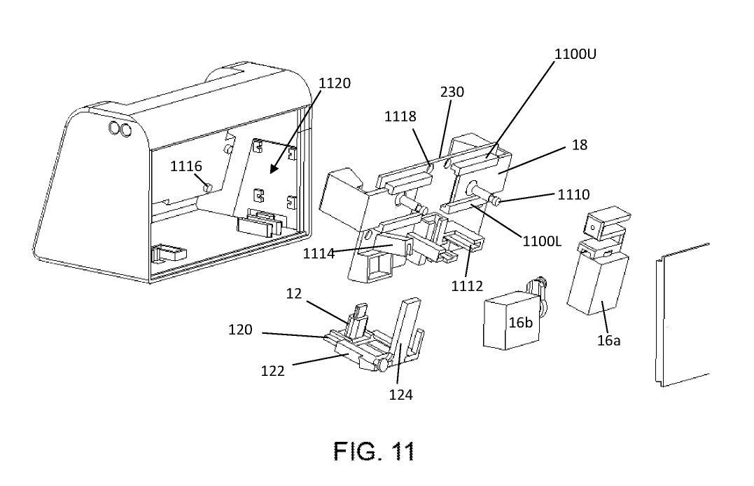

FIG. 11 shows a partially exploded rear isometric view of an embodiment of the present invention showing structural details. More specifically, the chassis 230 includes two opposing sets of rails allowing for linear motion of the mobile device positioning modules 18. The rails include two upper rails 1100U and two lower rails 1100L. The positioning modules 18 each include a mounting post 1110 for mounting the coil springs 42a and 42c. A first mounting bracket 1112 is shown on the lower back of chassis 230 adapted to receive the electromechanical component 16a in a fixed relation. A second mounting bracket 1114 is shown on the lower left back of the chassis 230 which is adapted to receive electromechanical component 16b in a fixed relation. A plurality of through-holes are shown in the chassis and are adapted to cooperate in an interference fit with pegs 1116 disposed on the interior of the housing 10. Also on the interior of the housing 10 is a chip mount 1120 including a set of four brackets for mounting an integrated circuit chip. FIG. 11 also includes an adjustment mechanism used for moving the position of the module that holds a plugged connector.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I/we claim:

1. An automated docking device, comprising:
a cradle (10) adapted to receive a mobile electronic device (38), the cradle (10) having a bottom support wall (150) and an adjacent back support wall (152) that cooperate to receive the mobile electronic device (38), and a pair of opposing lateral walls (154a, 154b) adjacent to the bottom support wall (150) and back support wall (152);
a pair of opposing automated positioning modules (18) extendable by one or more microprocessor-controlled motors (16) from the opposing lateral walls (154a, 154b) toward a center of the cradle (10), the pair of opposing automated positioning modules (18) being adapted to laterally position the mobile electronic device (38) between the pair of opposing lateral walls (154a, 154b);
a device sensor (22a, 22b) adapted to detect the presence of the mobile electronic device (38) in the cradle (10) according to a state change of the device sensor (22a, 22b), wherein the device sensor (22a, 22b) is further adapted to communicate its state to the microprocessor (20); and
an electrical connector (12, 14) adapted to engage the mobile device in electronic communication when the mobile electronic device is properly positioned.

2. The device of claim 1, further comprising a car mounting component adapted to be received by an automotive console cup holder.

3. The device of claim 1, wherein each of the automated positioning modules (18) comprises a chamfered positioning head (34) adapted to engage a front-edge of the mobile electronic device (38) forcing the mobile electronic device into the back support wall (152) as the positioning modules (18) move toward the center of the cradle.

4. The device of claim 3, further comprising a gripping pad disposed on a surface of each automated positioning module and adapted to contact the mobile electronic device.

5. The device of claim 1, wherein the motors of the pair of opposing automated positioning modules are adapted to drive the automated positioning modules a predetermined distance and/or until a predetermined amount of resistance is detected.

6. The device of claim 5, wherein each of the pair of opposing automated positioning modules further comprises a locking cam or electronic brake adapted to engage the automated positioning module in a fixed position in response to an indication of electrical communication being established between the mobile electronic device (38) and the electrical connector.

7. The device of claim 1, wherein the electrical connector is extendable by a microprocessor-controlled motor from a recess in the bottom support wall, and wherein the motor of the electrical connector is adapted to drive the electrical connector a predetermined distance and/or until a predetermined amount of resistance is detected.

8. The device of claim 7, further comprising a locking cam or electronic brake adapted to fix the electrical connector in a predetermined position in response to an indication of electrical communication being established between the mobile electronic device (38) and the electrical connector.

9. The device of claim 1, wherein the device sensor comprises a contact switch embedded in the bottom support wall, a beam-break sensor comprising a cooperating radiant source and detector, or a beam-reflection sensor comprising a cooperating radiant source and detector.

10. The device of claim 1, wherein the electrical connector comprises a transmitter coil of an inductive charging circuit.

11. The device of claim 1, wherein the electrical connector comprises a plug.

12. The device of claim 11, wherein the plug is adapted to correct for misalignment of the mobile electronic device the adaptation comprising a tapered plug, a narrowed plug, or a shortened plug.

13. The device of claim 12, wherein the plug further comprises one or more retaining clips adapted to mechanically engage the mobile electronic device.

14. The device of claim 1, further comprising a sensor in electronic communication with the microprocessor, the sensor being adapted to initiate a disconnection process in response to a predetermined signal.

15. The device of claim 14, wherein the sensor comprises a near infrared emitter and a near infrared detector configured in reflectance mode and adapted to detect near infrared reflections.
